(19) United States
(12) Patent Application Publication
(10) Pub. No.: US 2007/0295817 A1
(43) Pub. Date: Dec. 27, 2007

(54) AUTOMATIC DATA COLLECTION APPARATUS AND METHOD FOR VARIABLE FOCUS USING A DEFORMABLE MIRROR

(75) Inventors: Jean-Louis Massieu, Montauban (FR); Jean-Michel Puech, Toulouse (FR); Alain Gillet, Toulouse (FR); Denis Jolivet, Frouzins (FR)

Correspondence Address: SEED INTELLECTUAL PROPERTY LAW GROUP PLLC, 701 FIFTH AVENUE, SUITE 5400, SEATTLE, WA, 98104-7092, US

(73) Assignee: INTERMEC IP CORP., Everett, WA (US)

(21) Appl. No.: 11/765,827

(22) Filed: Jun. 20, 2007

Related U.S. Application Data
(60) Provisional application No. 60/805,556, filed on Jun. 22, 2006.

(51) Int. Cl. G06K 7/10

(52) U.S. Cl. 235/462.23

(57) ABSTRACT

An automatic data collection device, such as a scanner-type device, is provided with a deformable mirror that operates in conjunction with a scanning mirror to scan a target machine-readable symbol using a scanning beam. The deformable mirror includes a reflective membrane having a shape that can be changed by applying electric charge to conductors, or by some other type of actuation. In this manner, the focus distance, depth of field, wavefront shape, or other property of the scanning beam can be changed dynamically. Feedback information can be provided to a focus control algorithm to control adjustment of the deformable mirror so as to optimize the scanning.

### CROSS REFERENCE TO RELATED APPLICATION

The present application claims the benefit under 35 U.S.C. §119(e) of U.S. Provisional Patent Application Ser. No. 60/805,556, entitled “AUTOMATIC DATA COLLECTION APPARATUS AND METHOD FOR VARIABLE FOCUS USING A DEFORMABLE MIRROR,” filed Jun. 22, 2006, assigned to the same assignee as the present application, and incorporated herein by reference in its entirety.

### TECHNICAL FIELD

The present disclosure relates generally to electronic devices for reading data carriers, such as machine-readable symbols (e.g., barcodes, stacked codes, matrix codes, and the like), and more particularly but not exclusively, relates to techniques to provide variable focus when scanning machine-readable symbols.

### BACKGROUND INFORMATION

The automatic data collection (ADC) arts include numerous systems for representing information in machine-readable form. For example, a variety of symbologies exist for representing information in barcode symbols, matrix or area code symbols, and/or stacked symbols. A symbology typically refers to a set of machine-readable symbol characters, some of which are mapped to a set of human-recognizable symbols such as alphabetic characters and/or numeric values. Machine-readable symbols are typically comprised of machine-readable symbol characters selected from the particular symbology to encode information. Machine-readable symbols typically encode information about an object on which the machine-readable symbol is printed, etched, carried or attached to, for example, via packaging or a tag.

Barcode symbols are a common one-dimensional (1D) form of machine-readable symbols. Barcode symbols typically comprise a pattern of vertical bars of various widths separated by spaces of various widths, with information encoded in the relative thickness of the bars and/or spaces, each of which have different light reflecting properties. One-dimensional barcode symbols require a relatively large space to convey a small amount of data.

Two-dimensional symbologies have been developed to increase the data density of machine-readable symbols. Some examples of two-dimensional symbologies include stacked code symbologies. Stacked code symbologies may be employed where length limitations undesirably limit the amount of information in the machine-readable symbol. Stacked code symbols typically employ several lines of vertically stacked one-dimensional symbols. The increase in information density is realized by reducing or eliminating the space that would typically be required between individual barcode symbols.

Some other examples of two-dimensional symbologies include matrix or area code symbologies (hereinafter “matrix code”). A matrix code symbol typically has a two-dimensional perimeter, and comprises a number of geometric elements distributed in a pattern within the perimeter. The perimeter may, for example, be generally square, rectangular or round. The geometric elements may, for example, be square, round, or polygonal, for example hexagonal. The two-dimensional nature of such a machine-readable symbol allows more information to be encoded in a given area than a one-dimensional barcode symbol.

The various above-described machine-readable symbols may or may not also employ color to increase information density.

A variety of machine-readable symbol readers for reading machine-readable symbols are known. Machine-readable symbol readers typically employ one of two fundamental approaches, scanning or imaging.

In scanning, a focused beam of light is scanned across the machine-readable symbol, and light reflected from and modulated by the machine-readable symbol is received by the reader and demodulated. With some readers, the machine-readable symbol is moved past the reader, with other readers the reader is moved past the machine-readable symbol, and still other readers move the beam of light across the machine-readable symbol while the reader and machine-readable symbol remain approximately fixed with respect to one another. Demodulation typically includes an analog-to-digital conversion and a decoding of the resulting digital signal.

Scanning-type machine-readable symbol readers typically employ a source of coherent light such as a laser diode to produce a beam, and employ a beam deflection system such as a rotating or oscillating mirror to scan the resulting beam across the machine-readable symbols. Conventional laser scanning systems employ progressive symbol sampling.

In imaging, the machine-readable symbol reader may flood the machine-readable symbol with light, or may rely on ambient lighting. A one-dimensional (linear) or two-dimensional image (2D) capture device or imager such as a charge coupled device (CCD) array captures a digital image of the illuminated machine-readable symbol, typically by electronically sampling or scanning the pixels of the two-dimensional image capture device. The captured image is then decoded, typically without the need to perform an analog to digital conversion.

A two-dimensional machine-readable symbol reader system may convert, for example, two-dimensional symbols into pixels. See, for example, U.S. Pat. No. 4,988,852 issued to Krishnan, U.S. Pat. No. 5,378,883 issued to Batterman, et al., U.S. Pat. No. 6,330,974 issued to Ackley, U.S. Pat. No. 6,484,944 issued to Manine, et al., and U.S. Pat. No. 6,732,930 issued to Massieu, et al.

Regardless of the type of data carrier used, their usefulness is limited by the capability of a data collection device (such as a matrix code reader, barcode reader, and the like) to accurately capture the data encoded in the machine—readable symbol. Optical data collection devices are directional in nature-such devices need to be optimally positioned in order to accurately read the data on the target symbol. For example, if the data collection device is positioned too far from a target machine-readable symbol, then the target machine-readable symbol may be out of range or otherwise outside of an optimal focus distance of the data collection device. As a result, the data encoded in the target machine-readable system may not be read or may be read incorrectly. The inability of an inexperienced user to skillfully position the data collection device also contributes to the directional limitations of such devices, thereby further contributing to the chances of erroneous or missed data readings.

To assist the user in accurately reading machine-readable symbols, some data collection devices are provided with variable focusing features, which attempt to find the best focus distance. For example, a device disclosed by Plesko (U.S. Pat. No. 5,864,128) uses a lens having a variable focal length. The lens is formed by a cavity filled with a gel. A surface adjacent to the cavity can be deformed by controlling internal pressure applied to the gel in the cavity, thereby varying the focal length of the lens.

A device disclosed by Brobst (U.S. Pat. No. 6,053,409) uses a piezoelectric deformable mirror that directs light to a scanning mirror. The curvature of the deformable mirror can be changed to vary the depth of field of his device. Brobst uses a separate and dedicated distance sensor to provide the distance to the target machine-readable symbol, and this distance information is used to determine the amount of deformation of the deformable mirror.

There are disadvantages associated with these types of devices. For example, the separate distance sensor of Brobst adds complexity and cost to his device. Moreover, the specific distance sensor used by Brobst inhibits the portability of his device. With Plesko, the use of internal pressure to deform the lens is not particularly suited for fine adjustment and/or fine control.

### BRIEF SUMMARY OF THE INVENTION

One aspect provides a method for reading data carriers such as machine-readable symbols using an automatic data collection device. The method includes generating a light beam, directing the light beam to a deformable mirror, directing the light beam from the deformable mirror to a target machine-readable symbol, receiving light returned from the target machine-readable symbol, evaluating the received light to provide feedback information indicative of a property associated with the light beam, and changing a shape of the deformable mirror based on the feedback information.

### BRIEF DESCRIPTION OF THE SEVERAL VIEWS OF THE DRAWINGS

Non-limiting and non-exhaustive embodiments are described with reference to the following figures, wherein like reference numerals refer to like parts throughout the various views unless otherwise specified.

FIG. 1 is an upper isometric view of an embodiment of an automatic data collection device directing a scanning beam towards at least one target machine-readable symbol, such as a barcode symbol.

FIG. 2 is a functional block diagram of an embodiment of a data collection device, such as the data collection device of FIG. 1, that includes a deformable mirror.

FIG. 3 is top diagrammatic view showing example optical paths for one embodiment of the data collection device of FIG. 2.

FIG. 4 is another top diagrammatic view showing example optical paths for one embodiment of the data collection device of FIG. 2.

FIG. 5 is a flow diagram of an embodiment of a method to change a shape of the deformable based on feedback information.

FIGS. 6-8 illustrate an embodiment of a process for manufacturing an example deformable mirror for the data collection device of FIG. 2.

### DETAILED DESCRIPTION

Embodiments of an automatic data collection apparatus and method for variable focus using a deformable mirror are described herein. In the following description, numerous specific details are given to provide a thorough understanding of embodiments. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Unless the context requires otherwise, throughout the specification and claims which follow, the word “comprise” and variations thereof, such as, “comprises” and “comprising” are to be construed in an open, inclusive sense, that is as “including, but not limited to.”

The headings provided herein are for convenience only and do not interpret the scope or meaning of the claimed invention.

As an overview, an automatic data collection device of an embodiment is provided for reading a target machine-readable symbol, such as barcode symbols, stacked code symbols, matrix code symbols, or other types of one-dimensional (1D) or two-dimensional (2D) machine-readable symbols by scanning. The data collection device includes a light source to provide a scanning beam to scan the target machine-readable symbol and a scanning mirror to deflect the scanning beam across the target machine-readable symbol. The scanning mirror of one embodiment is a microelectromechanical structure (MEMS) mirror.

In one embodiment, the automatic data collection device further includes a deformable mirror that operates in conjunction with the scanning mirror to enhance reading capabilities from near to far fields, or to otherwise improve focusing or other optical capabilities of the data collection device. The deformable mirror provides dynamic wavefront correction so as to control the focus and/or beam divergence, while the scanning mirror creates a back and forth exploration of the region of the target machine-readable symbol that is being scanned. The deformable mirror can comprise a deformable silicon membrane in one embodiment.

An embodiment of the automatic data collection device can further include a focus control algorithm that attempts to optimize the focus, in response to degrees of focus that are measured from incoming scan data from the target machine-readable symbol. A decoding algorithm of the automatic data collection device can be provided with the incoming scan data that is usable to measure or otherwise determine the degrees of focus, and can then provide this feedback information to the focus control algorithm to allow the focus control algorithm to generate control signals to change the shape of the deformable mirror. Thus, the longer a user of the automatic data collection device waits, the sharper (or more focused and accurate) the scanning operation and the resultant scanning data can become.

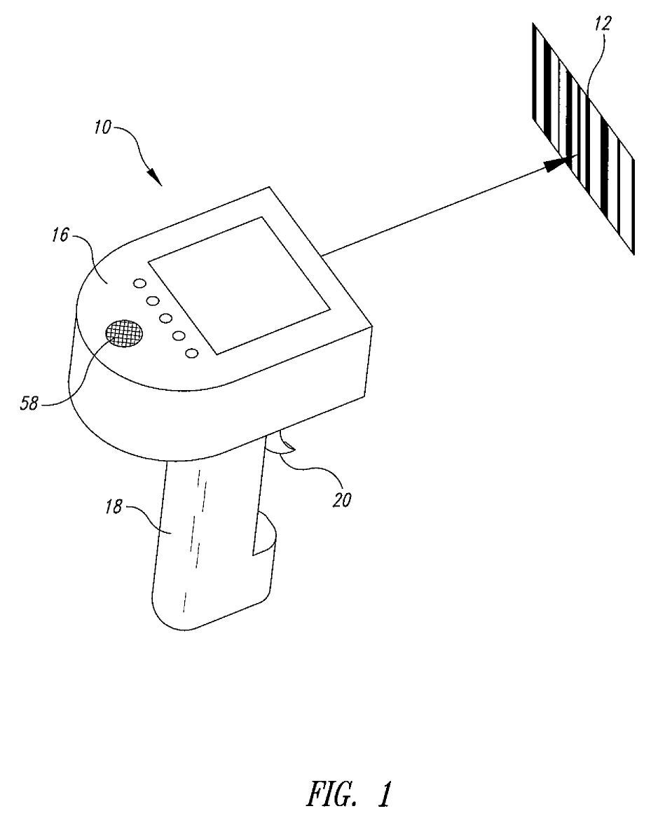

FIG. 1 shows an automatic data collection device 10 for reading one or more target machine-readable symbols, such a barcode symbol 12 or some other machine-readable symbol using a scanning technique. While the barcode symbol 12 is illustrated, it is appreciated that the target machine-readable symbol may be embodied as any other type of one-dimensional (1D) or two-dimensional (2D) machine-readable symbol that can be scanned by a scanning beam 14. A stacked code symbol is but one example of a 2D symbol that can be scanned. For the sake of simplicity of explanation hereinafter and unless the context is otherwise, the various embodiments pertaining to the data collection device 10 will herein be described with respect to a target machine-readable symbol being in the form of the barcode symbol 12.

The data collection device 10 includes a head 16, a handle 18, and an actuator such as a trigger 20. While the trigger 20 is shown with a specific shape and in a specific location in the embodiment of FIG. 1, other embodiments may employ different arrangements. For example, the trigger 20 can be embodied as a side-mounted finger trigger, top-mounted thumb trigger, button or key, touch screen, and other arrangements. One embodiment further provides a proximity trigger, which uses optics, acoustics, or other mechanism to determine proximity of an object to automatically activate without requiring a user to pull the trigger. In one embodiment, the trigger 20 can be implemented as a multi-position trigger that can be pulled/pressed in stages. For example, an initial press (e.g., pressing the trigger 20 halfway) can be used to perform focusing, and a further press (e.g., further pressing the trigger 20 to its fully pressed position) can be used to perform final data acquisition via scanning. In other embodiments, the trigger 20 can be actuated using successive trigger pulls to perform certain operations, analogous to single or double clicking a mouse.

The data collection device 10 can comprise a portable data collection device, a hand-held scanning device, or other suitable electronic device having the various data reading capabilities described herein. It is appreciated that some embodiments are provided that may not necessarily have the same shape or identical features or identical use as the embodiments illustrated in the various figures. However, such embodiments can nevertheless include a deformable mirror as will be explained in detail below.

The scanning beam 14 is symbolically depicted (for purposes of simplicity) in FIG. 1 as a single line, which represents one or more beams of light directed at and scanned across the barcode symbol 12. The scanning beam 14 can comprise diverging light, collimated light, or other beam profile or wavefront shape.

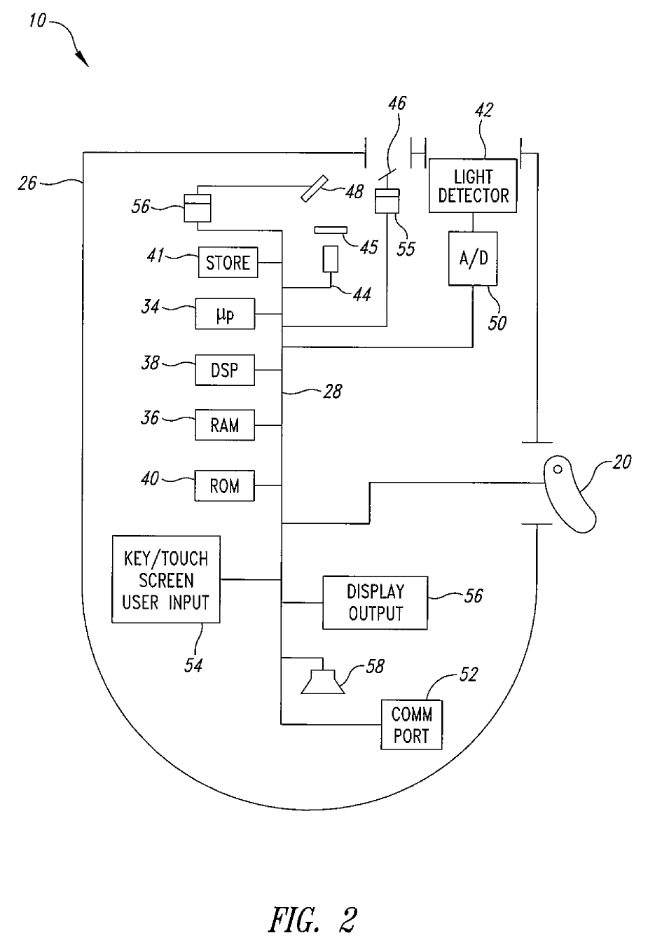

FIG. 2 is a functional block diagram of an embodiment of the data collection device 10. While the block diagram of FIG. 2 depicts a dedicated 1D and/or 2D data collection device that uses scanning (i.e., a single-mode device), such a data collection device is illustrated and described herein as a single-mode device only for convenience and clarity. The features depicted in the illustrated embodiment(s) can be suitably implemented in a multi-mode data collection device that is capable to read any one or more of 1D, 2D, or other type of machine-readable symbols using scanning or imaging, and/or which may additionally read other types of automatic data collection (ADC) data carriers, including RFID and acoustical data carriers, for example.

As shown in the embodiment of FIG. 2, the data collection device 10 has a housing 26 that carries various components, symbolically shown as being coupled together via a bus 28. The bus 28 provides data, commands, signals, and/or power to the various components of the data collection device 10. The data collection device 10 can include an internal power source such as a rechargeable battery (not shown), or can receive power from an external power source such as a wall outlet by way of an electrical cord (not shown).

In one embodiment, the data collection device 10 includes a light detector 42 and one or more light sources 44 to generate light for the scanning beam 14 that reads a target machine-readable symbol, such as the barcode symbol 12. An example of the light source 44 of one embodiment is a laser, light emitting diode (LED), or other suitable light source that can be used for scanning the target barcode symbol 12.

The data collection device 10 can employ suitable optics such as one or more lenses 45 (such as a pre-focusing lens), a deformable mirror 48, and a scanning mirror 46 that is used to move the scanning beam 14 across the target barcode symbol 12. In operation, the light source 44 generates a light, and the light is then directed through the lens 45 (which can for example collimate the light) to the deformable mirror 48. The deformable mirror 48 then reflects or returns or otherwise directs the light onto the scanning mirror 46.

The scanning mirror 46 is driven or otherwise actuated by an actuator 55, so as to cause the light incident thereon to be scanned across the target barcode symbol 12 as the scanning beam 14. In one embodiment, the scanning mirror 46 comprises a MEMS mirror, and the actuator 55 can comprise an electrostatic actuator, a piezoelectric actuator, or a magnetic actuator.

The deformable mirror 48 of an embodiment comprises a deformable silicon membrane. The components of an embodiment of the deformable mirror 48 and an embodiment of a process for manufacturing the deformable mirror 48 will be described in more detail later below.

In an embodiment, the deformable mirror 48 is deformed (or otherwise actuated in a manner that the shape of the deformable mirror 48 is changed) by an actuator 56. The actuator 56 can comprise an electrostatic actuator, a piezoelectric actuator, or a magnetic actuator. For example, with an embodiment of the deformable mirror 48 that includes electrodes for applying repulsive/attractive electrostatic forces to a deformable silicon membrane, the actuator 56 can be an electrostatic actuator that applies the appropriate amount and the appropriate polarity of voltage potentials to specific electrodes.

The light detector 42 (such as a photodetector, phototransistor, or other type of light detector) can be positioned in a manner to sense light from the scanning beam 14 that is reflected or otherwise returned back from the target barcode symbol 12 and to generate an analog electrical signal (or other type of signal) representative of the received returned light.

An analog-to-digital (A/D) converter 50 transforms the analog electrical signals from the photodetector 42 and/or other signals into digital signals. For example for returned light that is received by the photodetector 42 that contains encoded data, the digital signals obtained from the received signals can be processed to decode or otherwise obtain the underlying encoded data.

In an embodiment, the signal generated by the light detector 32 also can be used to determine a degree of focus or other characteristic associated with the scanning beam 14. For example and as will be explained in further detail below, the signal generated by the light detector 42 can be analyzed to determine whether improved focusing is needed to get an improved read of the target barcode symbol 12, and if necessary, such feedback information can be used cause the deformable mirror 48 to change its shape to thereby change the focus.

The data collection device 10 of FIG. 2 includes at least one microprocessor, controller, microcontroller, or other processor, which are symbolically shown as the single microprocessor 34. It is appreciated that the data collection device 10 may include separate dedicated processors for reading and processing barcode symbols, stacked code symbols, matrix code symbols, RFID tags, acoustical tags, or other types of other data carriers, as well as one or more processors for controlling operation of the data collection device 10.

Moreover, in one example embodiment at least one digital signal processor (DSP) 38 may be provided to cooperate with the microprocessor 34 to process signals and data returned from the symbols. Such signal processing may be performed for purposes of reading data from signals received from the target machine-readable symbol. For instance during decoding, the DSP 38 can perform image processing to extract the encoded data from the scanned target barcode symbol 12. The DSP 38 can also be used to process signals that result from scanning other types of 1D or 2D machine-readable symbols and/or from imaging machine-readable symbols (if the data collection device 10 is a multi-mode device having imaging capability).

In an embodiment, the microprocessor 34 can execute software or other machine-readable instructions stored in a machine-readable storage medium in order to perform the decoding or to otherwise control operation of the data collection device 10, including operations associated with determining the degree of focus (or other property/characteristic) of the scanning beam 14 based on the data provided by the A/D converter and operations associated with making adjustments to the shape of the deformable mirror 48 to change the focus or other characteristic of the scanning beam 14. Such a storage medium can be embodied by a random access memory (RAM) 36, a read only memory (ROM) 40, or other storage medium 41. The software stored in the storage medium 41, for example, can include the focus control algorithm that can be used to assess the degree of focus, depth of field, or other scanning-related feature of the data collection device 10, and that can then initiate adjustment of the deformable mirror 48.

As used in this herein, the ROM 40 includes any non-volatile memory, including erasable memories such as EEPROMs. The RAM 36 is provided to temporarily store data, such as a digital data from the A/D converter 50. The RAM 36 can also store other types of data, such as variable values, results of calculations, state data, or other information.

Symbol reading and decoding technology is well known in the art and will not be discussed in further detail. Many alternatives for scanners, symbol decoders, and optical elements that can be used in the data collection device 10a are taught in the book, The Bar Code Book, Third Edition, by Roger C. Palmer, Helmers Publishing, Inc., Peterborough, N.H., U.S.A. (1995) (ISBN 0-911261-09-5). Useful embodiments can also be derived from the various components disclosed in U.S. Pat. No. 6,286,763, issued Sep. 11, 2001, and assigned to the same assignee as the present application.

The data collection device 10 can include a communication port 52 to provide communications to external devices. The communication port 52 can be a hardwire or wireless interface, and can even employ an antenna, radio, USB connection, Ethernet connection, modem, or other type of communication device. The communication port 52 can provide communications over a communications network (not shown) to a host (not shown), allowing transmissions of data and/or commands between the data collection device 10 and the host. The communications network can take the form of a wired network, for example a local area network (LAN) (e.g., Ethernet, Token Ring), a wide area network (WAN), the Internet, the World Wide Web (WWW), wireless LAN (WLAN), wireless personal area network (WPAN), and other network. Alternatively or additionally, the communications network can be a wireless network, for example, employing infrared (IR), satellite, and/or RF communications.

The data collection device 10 includes a keypad, mouse, touch screen, or other user input device 54 to allow user input. It is appreciated that other devices for providing user input can be used. The user input device 54 is usable to allow the user to select modes (e.g., modes for reading matrix code symbols, barcode symbols, or other symbols), turn the data collection device 10 ON/OFF, adjust power levels, and others. The bus 28 couples the user input device 54 to the microprocessor 34 to allow the user to enter data and commands.

The bus 28 also couples the trigger 20 to the microprocessor 34. In response to activation of the trigger 20, the microprocessor 34 can cause the light source 44 to generate light that can be used as the scanning beam 14. In one embodiment, an initial press of the trigger 20 can be used to generate the scanning beam 14 to scan the target barcode symbol 12 and to initiate analysis of the returned light to determine degree of focus, depth of field, or other optical feedback information for adjusting the deformable mirror 48. Then, a subsequent or additional pressing of the trigger 20 can be used to initiate the final scanning, after the degree of focus or other characteristic associated with the scanning beam 14 has been optimized.

The data collection device can 10 include human-perceptible visual (e.g., a display output) and audio indicators 56 and 58 respectively. The bus 28 couples the visual and audio indicators 56 and 58 to the microprocessor 34 for control thereby. The visual indicators 56 take a variety of forms, for example: light emitting diodes (LEDs) or a graphic display such as a liquid crystal display (LCD) having pixels. These or other visual indicators can also provide other data associated with the operation of the data collection device 10, such as visual indicators to indicate whether the data collection device 10 is ON/OFF, reading, interrogating, low on battery power, successful or unsuccessful reads/interrogations, and so forth.

The audio indicator 58 can take the form of one or more dynamic electrostatic or piezo-electric speakers, for example, operable to produce a variety of sounds (e.g., clicks and beeps), and/or frequencies (e.g., tones), and to operate at different volumes. Such sounds can convey various types of information, such as whether a symbol was successfully or unsuccessfully read, low battery power, or other information.

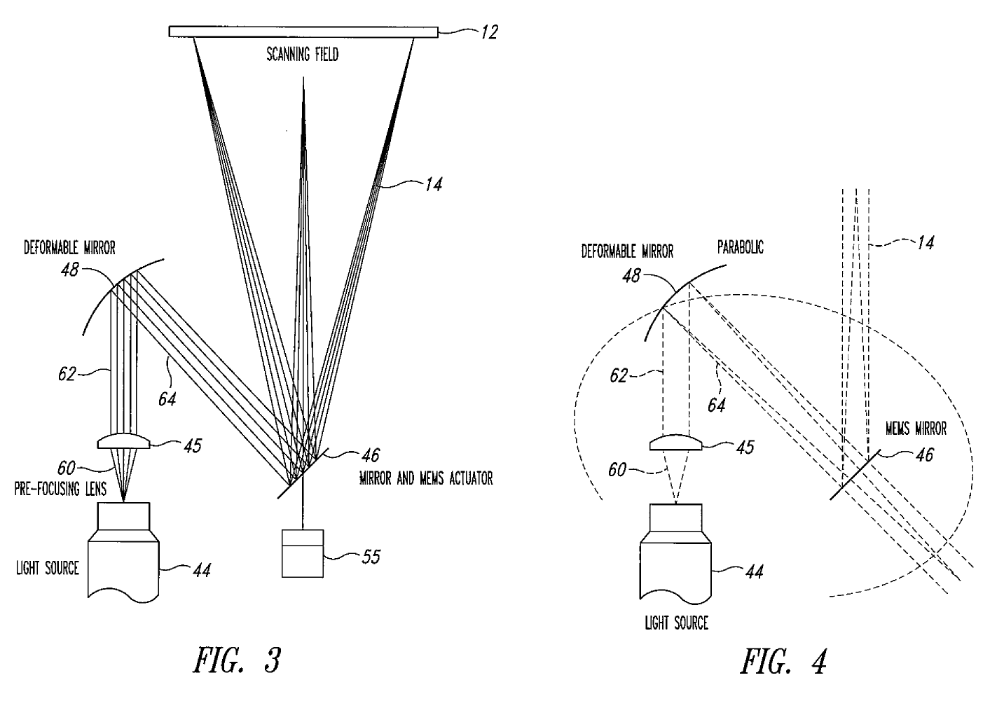

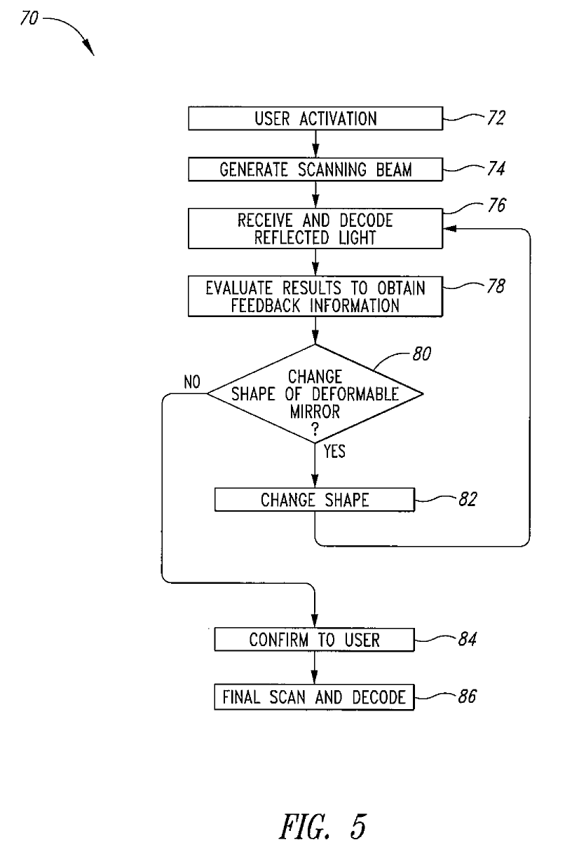

FIGS. 3-4 are top diagrammatic views showing example optical paths for the scanning beam 14, based on the position (and shape) of the deformable mirror 48 relative to the scanning mirror 46 (such as a MEMS mirror). It is appreciated that the various positions, optical paths, shape or other optical property of the scanning beam 14, or other representation in FIGS. 3-4 are merely for purposes of discussion and illustration. Other embodiments of the data collection device 10 may be different from the embodiments specifically shown and described with reference to FIGS. 3-4.

Referring first to FIG. 3, the light source 44 generates light 60 for the scanning beam 14. The light source 44 can generate the light 60, for example, when the user presses the trigger 20 to begin scanning the barcode symbol 12. The generated light 45 passes through the lens 45, which can perform pre-focusing functions. For example, the lens 45 can collimate the generated light 45 passing thereto, thereby producing collimated light 62.

The lens 45 directs the collimated light 62 onto a reflective surface of the deformable mirror 48. The deformable mirror 48 is shaped and positioned such that the collimated light 62 incident thereon is directed to the scanning mirror 46. The light received by the scanning mirror 46 from the deformable mirror 48 is represented in FIG. 3 at 64. The scanning mirror 46 is actuated by the actuator 55 in a manner that the scanning beam 14, formed from the light 64 incident on the scanning mirror 46, moves across a scanning plane to scan the target barcode symbol 12.

FIG. 4 illustrate an example effect as a result of changing the shape of the deformable mirror 48. For example, the deformable mirror 48 can have a generally flat shape, a parabolic shape, an elliptical shape (depicted in FIG. 4 in broken lines), or other types of shapes and/or combinations thereof. By changing the shape of the reflective surface of the deformable mirror 48, the focal length, divergence, depth of field, wavefront shape, or other property associated with the light 64 (and hence with the scanning beam 14 can be changed).

As an example, if the reflective surface of the deformable mirror 48 has a generally flat shape, then the focal distance is theoretically at infinity. If the reflective surface of the deformable mirror 48 is changed to a generally elliptical shape, then the focal distance can be suitably controlled or otherwise set to a distance for optimum scanning, such as a 200 mm focus distance between the target barcode symbol 12 and the data collection device 10 in some situations. Therefore, to provide longer focal distances (thus also increasing the depth of field), the reflective surface of the deformable mirror 48 can be deformed to a flatter shape, as compared to a shape with a more pronounced curvature (for shorter focal distances and a decrease of the depth of field).

Controlling more accurately the wavefront of the light 64 enables increased control of beam divergence. Providing a profile of the light 64 (and hence the scanning beam 14) in this manner can produce a quasi-free diffraction effect in one embodiment, where a center peak of the scanning beam 14 can be invariant over an extended range. Furthermore, it is possible to extend the identification depth of field measured at a low modulation transfer function (MTF).

In an embodiment, the shape of the deformable mirror 48 can be controlled in a manner that addresses comas or other types of optical aberrations. For example, due to an angle of incidence of the collimated light 62 on the reflective surface of the deformable mirror 48, a coma (off-axis light rays that do not converge at a focal plane) may result. However, an embodiment can correct or otherwise compensate for this coma by providing the reflective surface of the deformable mirror 48 with an asymmetric curvature. For instance, one or more electrodes (or other conductors or actuators) underneath the reflective surface of the deformable mirror 48 can be slightly shifted off-center to provide the appropriate asymmetric curvature, such as where a curvature on one side relative to the center is different than a curvature on a second side relative to the center.

In an embodiment, the shape of the deformable mirror 48 can be controlled or otherwise tailored using an arrangement of electrodes that produce an electric field that applies forces to the deformable mirror 48. Voltage potentials can be applied to the electrodes to dynamically change the shape of the deformable mirror 48, such as in response to feedback information that indicates a need to change focus.

In an embodiment, the manner in which to apply the voltage potentials (e.g., specific voltage amplitudes, selection of specific electrodes to receive the voltage potentials, sequence and timing of application of the voltage potentials, etc.) can be based on pre-loaded maps or other settings contained in the storage medium 41 (or other storage medium) that are used by the microprocessor 34. For example, with regards to sequence and timing, voltage potentials can be applied to certain electrodes before other electrodes. The geometry or other manner of arrangement of the electrodes can include, but not be limited to, concentric, sectored, striped, annular, checkerboard, matrix, or other suitable electrode arrangement.

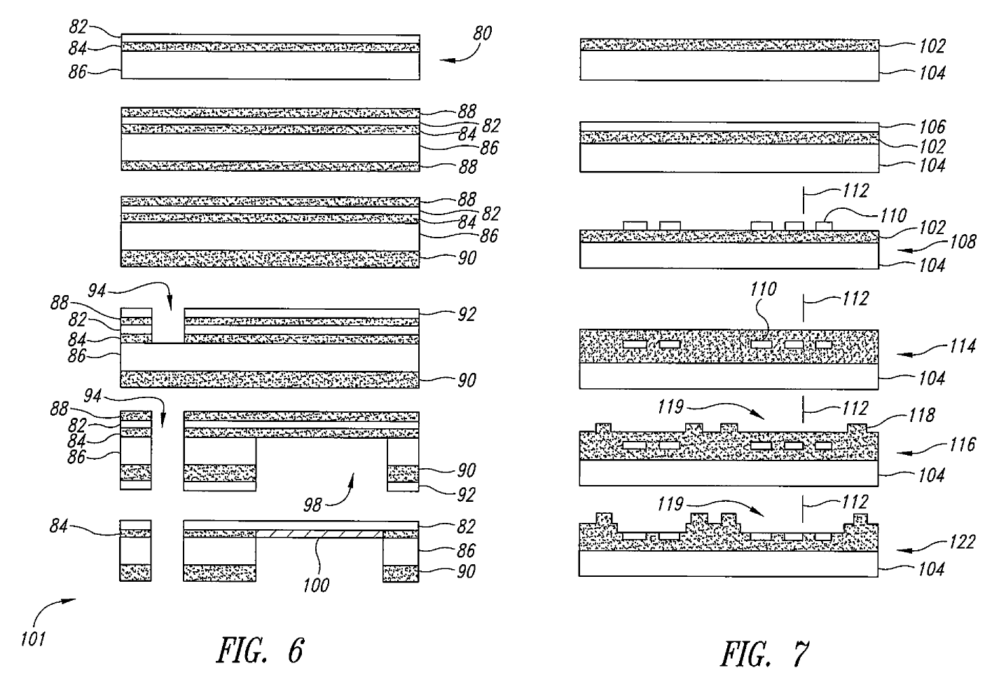

FIG. 5 is a flow diagram 70 of a technique that involves scanning the target barcode symbol 12 and making adjustments to the shape of the deformable mirror 48 based on feedback information, such as determinations of degree of focus. In an embodiment, some of the operations depicted in the flow diagram 70 can be implemented through software or other machine-readable instructions executable by a processor (such as the microprocessor 34) and stored on a machine-readable medium (such as the storage medium 41, the RAM 36, or the ROM 40). It is appreciated certain operations in the flow diagram 70 can be suitably added, removed, combined, or modified in other embodiments, and that the various operations need not necessarily be performed in the exact manner shown.

The user activates the data collection device 10 for scanning the target barcode symbol 12 at a block 72. In one embodiment, pressing the trigger 20 can cause this activation. In yet another embodiment, the user can partly (not fully) press the trigger 20 at the block 72, thereby initiating a process in which scanning and decoding is performed to determine degree of focus, for example, for changing the shape of the deformable mirror 48 for adjustment purposes, but without yet performing final data acquisition.

The light source 44 generates the scanning beam 14 at a block 74. For example and as shown in FIG. 3, the light source 44 can generate the light 60, which is then collimated by the lens 45. The resulting collimated light 62 is directed by the deformable mirror 48 to the scanning mirror 46 as the light 64, which is then output and scanned across the target barcode symbol 12 as the scanning beam 14 by the scanning mirror 46.

The light detector 42 receives the returned light from the target barcode symbol 12 at a block 76, and the returned light is converted to digital data by the A/D converter 50. The decoding algorithm decodes the digital data to obtain the data encoded in the target barcode symbol 12.

Whether or not to change the shape of the deformable mirror 48 (and by how much) can be based on one or more of the returned light (in analog form) received by the light detector 42, the digital data provided by the A/D converter 50, or the data decoded from the digital data. Such determination or other evaluation can be performed at a block 78.

For example, the strength of the analog signal provided by the light detector 42 can be indicative of the focal distance between the target barcode symbol 12 and the data collection device 10. If the strength of the analog signal is too weak or otherwise falls below some minimum threshold level, then such a condition may indicate that the data collection device 10 is positioned too far from the target barcode symbol 12. Therefore, the curvature of the deformable mirror 48 may be decreased (to increase the flatness of the shape), thereby lengthening the focal distance.

Conversely, if the strength of the analog signal is too strong or otherwise exceeds some maximum threshold level, then such a condition may indicate that the data collection device 10 is positioned too close to the target barcode symbol 12. Therefore, the curvature of the deformable mirror 48 may be increased (to decrease the flatness of the shape), thereby shortening the focal distance.

In one embodiment, the digital data provided by the A/D converter 50 is evaluated at the block 78 using the focus control algorithm stored in the storage medium 41 and executable by the microprocessor 34. For instance, the digital data can be evaluated for values that fall within or outside of certain expected values.

In yet another embodiment, the decoded data can be evaluated. For example, the decoding algorithm can decode the digital data, and then the focus control algorithm evaluates the results of the decoding. If the decoded data indicates missing or incorrect characters (characters from a UPC code, for instance), then such a result may indicate that the target barcode symbol 12 is positioned too far away, thereby resulting in missing/incorrect data.

As yet another example to evaluate the digital data and/or the decoded data, the digital data and/or the data decoded therefrom as a result of two or more scanning operations can be compared with one another. If two or more consecutive scans of the same barcode symbol 12 result in identical decoded data or other identical values, then such a condition may indicate that the proper focal length is present. Conversely, if there are inconsistent results in decoding data from the same target barcode symbol 12, then such a condition may indicate that the focal distance is not correct, thereby resulting in erroneous readings.

Other techniques for evaluating the analog signal, the digital data, the results of the decoding, etc. can be used by the focus control algorithm to determine the degree of focus, depth of field, or other property associated with the scanning beam 14 at the block 78.

At a block 80, the microprocessor 34 cooperates with the focus control algorithm to determine whether and to what degree to change the shape of the deformable mirror, based on the evaluation performed at the block 78 that generates feedback information. If the evaluation at the block 78 indicates that the shape of the deformable mirror 48 needs to be changed (such as to change the focal distance), then the shape of the deformable mirror is changed at a block 82.

As explained above for one embodiment, the shape of the deformable mirror 48 can be changed or otherwise controlled by application of voltage potentials to electrodes of the deformable mirror 48. The changes may be provided incrementally, until an optimum shape of the deformable mirror 48 is obtained. Therefore, the process described above in blocks 76-82 can be repeated as necessary (e.g., decoding, evaluating results, changing the shape in response, etc.).

If the microprocessor 34 determines that no further change in the shape of the deformable mirror 48 is needed at the block 80, such as if the focal length is optimum, then a confirmation can be provided to the user at a block 84. For example, a flashing light, a green light, a beep, or other indicator can be provided to the user to indicate that the focus is optimum. The user can then fully press the trigger 20 or take some other action to perform the final scan and/or final decode at a block 86. Alternatively or additionally, the final scan and/or final decode need not necessarily be performed at the block 86—the scanning and decoding result before confirmation of optimum focus can be used as the “final” result, without having to perform additional scanning or decoding.

In one embodiment, the audio or visual confirmation to the user at the block 84 need not be provided. The final result of the decoding, after having reached optimum focus, can be identified and processed appropriately in a manner transparent to the user and without requiring any further action from the user.

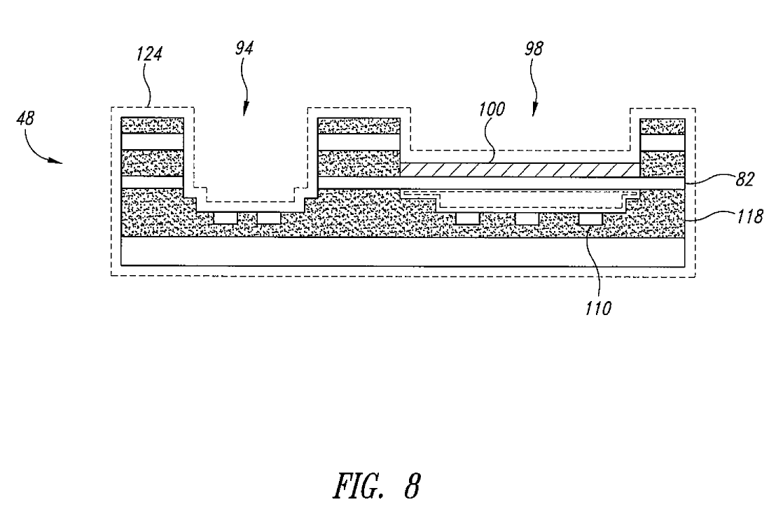

FIGS. 6-8 illustrate an embodiment of a process to manufacture the deformable mirror 48. Some of the steps shown in one embodiment of the process of FIGS. 6-8 can be based on a technique described in Fanget et al., “Integrated Deformable Mirror on Silicon for Optical Data Storage,” MOEMS Display and Imaging Systems III, Procedures of SPIE volume 5721-19, pages 159-169, 2005. In an embodiment, the deformable mirror 48 can include, in whole or in part, MEMS components.

Referring first to FIG. 6, a silicon on insulator (SOI) wafer 80 is provided, which comprises a silicon film 82 (which will form the silicon membrane of the deformable mirror 48) on buried silica 84 over a bulk silicon 86. Then, a thermal oxidation of both sides of the wafer 80 is performed to provide silica layers 88 to equalize strain on the silicon film 82 (in the future silicon membrane).

Then, silica 90 is deposited via plasma enhanced chemical vapor deposition (PECVD) on the backside of the wafer 80 to act as a mask for backside etching. Afterwards, a first photolithography level (such as by using a photoresist 92) is realized on the front side of the wafer 80, followed by a dry etching of the surface layers 88, 82, and 84 up to the bulk silicon 86, thereby providing an aperture 94 for future electrical connections.

The photoresist 92 is stripped. A second photolithography (such as by using a photoresist 96) is performed on the backside of the wafer 80 to complete the aperture 94 for the electrical connections an aperture 98 for the reflective portion of the deformable mirror 48.

The silica 90 and bulk silicon 86 are dry etched to the buried silica 84. Next, the silica layers 88 on both sides of the wafer 80 are chemically etched to expose the silicon film 82, followed by metallic deposition to obtain a reflective surface 100, thereby resulting in a final mirror substrate portion 101. Any type of suitable metal material can be used for the metallic deposition for the reflective surface 100, including silver, gold, or other metallic material that can provide adequate reflectivity.

Referring next to FIG. 7, the process used to form the electrode substrate portion of the deformable mirror 48 is shown. A thermal oxidation of a silica layer 102 over a silicon wafer 104 is performed. Next a titanium layer 106 (or other conductive metal material) is realized by sputtering deposition, thereby obtaining the metal material for the electrodes.

A first photolithography and chemical etching is performed at 108 to form specific individual electrodes 110. In an embodiment, at least some of the electrodes 110 are shifted away from a center 112 of the deformable mirror 48, such that the electrodes 110, when applied with voltage potentials, will deform the reflective surface 100 asymmetrically about the center 112. For example, a first part of the reflective surface 100 (on one side of the center 112) may have a more pronounced curvature relative to a second part of the reflective surface 100 (on another side of the center 112). As explained above, this is feature can be provided to correct for coma and/or other aberrations due to the angle of incidence of the light impinging on the reflective surface 100.

In one embodiment, this offset shifting of the electrodes 110 can be obtained by placing a greater number of electrodes on one side of the center 112, as compared to a second side of the center 112, for example. Alternatively or additionally, the electrodes 110 within either or both sides of the center 112 may be irregularly spaced.

PECVD deposition is then performed at 114 to encapsulate the electrodes 110 in silica. At 116, a second photolithography and etching is performed to form thrusts 118 that will support the mirror substrate portion 101 shown in FIG. 6. A third photolithography is performed to provide a cavity 119 in which the silicon membrane (e.g., the silicon film 82) is actuated. The silica is dry etched up to the metal electrodes 110 to form a final electrode substrate portion 122.

FIG. 8 shows the final deformable mirror 48. A polymer paste or other suitable glue is applied to the thrusts 118 to bond or otherwise attach the mirror substrate portion 101 of FIG. 6 with the electrode substrate portion 122 of FIG. 7. Electrical contacts to the electrodes 110 can be provided with gold wires or other suitable conductive material.

A seal 124 may be applied over to one or more surfaces of the deformable mirror 48 (e.g., over the silicon film 82, the reflective surface 100, the electrode substrate portion 122, the mirror substrate portion 101, etc.). With the deformable mirror 48 thus assembled, the deformable mirror 48 can then be installed into the data collection device 10, along with other components described above.

Therefore, from the description provided above, it is evident that one embodiment of the deformable mirror 48 provides finer control and tuning of the scanning beam 14. Furthermore, use of the feedback information for determining whether to adjust the shape of the deformable mirror 48 removes the need for a separate dedicated distance sensor to determine whether or not to make adjustments.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments, including what is described in the Abstract, is not intended to be exhaustive or to limit the invention to the precise forms disclosed. While specific embodiments and examples are described herein for illustrative purposes, various equivalent modifications are possible within the scope of the invention and can be made without deviating from the spirit and scope of the invention.

For example, the data collection device 10 has been described above in the context of a scanner-type device having the deformable mirror 48. It is appreciated that an embodiment can be provided where the data collection device 10 includes imaging capabilities, such as for imaging matrix code symbols or for imaging other types of 1D and/or 2D machine-readable symbol using imaging light. In such embodiments, the deformable mirror 48 can be used to change a shape of an imaging field, a divergence of an imaging beam, a focus of the imaging beam, or other property associated with the imaging light.

These and other modifications can be made to the embodiments in light of the above detailed description. The terms used in the following claims should not be construed to limit the invention to the specific embodiments disclosed in the specification and the claims, but should be construed to include all possible embodiments along with the full scope of equivalents to which such claims are entitled. The scope of the invention is to be determined entirely by the following claims, which are to be construed in accordance with established doctrines of claim interpretation.

What is claimed is:

1. A method for reading data carriers such as machine-readable symbols using an automatic data collection device, the method comprising:
generating a light beam;
directing the light beam to a deformable mirror;
directing the light beam from the deformable mirror to a target machine-readable symbol;
receiving light returned from the target machine-readable symbol;
evaluating the received light to provide feedback information indicative of a property associated with the light beam; and
changing a shape of the deformable mirror based on the feedback information.

2. The method of claim 1 wherein directing the light beam from the deformable mirror to the target machine-readable symbol includes:
directing the light beam from the deformable mirror to a scanning mirror; and
actuating the scanning mirror to scan the light beam across the target machine-readable symbol.

3. The method of claim 1 wherein directing to the target machine-readable symbol includes directing the light beam to a barcode symbol.

4. The method of claim 1 wherein evaluating the received light to provide feedback information indicative of the property associated with the light beam includes evaluating the received light to determine a degree of focus.

5. The method of claim 1 wherein evaluating the received light to provide feedback information indicative of the property associated with the light beam includes evaluating the received light to determine depth of field.

6. The method of claim 1 wherein changing the shape of the deformable mirror based on the feedback information includes applying a voltage potential to at least one electrode of the deformable mirror to generate a force to deform the deformable mirror.

7. The method of claim 1 wherein changing the shape of the deformable mirror based on the feedback information includes applying a voltage potential to at least one electrode of the deformable mirror that is shifted from a center of the deformable mirror in a manner to correct an aberration associated with the light beam.

8. The method of claim 1 wherein evaluating the received light to provide feedback information indicative of the property associated with the light beam includes evaluating a characteristic of an analog signal or a digital signal associated with the received light.

9. The method of claim 1, further comprising decoding the received light to obtain decoded data, wherein evaluating the received light to provide feedback information indicative of the property associated with the light beam includes evaluating the decoded data to determine the feedback information.

10. The method of claim 1 wherein changing the shape of the deformable mirror includes increasing a curvature of the deformable mirror to decrease a focal distance to the target machine-readable symbol.

11. The method claim 1 wherein changing the shape of the deformable mirror includes decreasing a curvature of the deformable mirror to increase a focal distance to the target machine-readable symbol.

12. The method of claim 1 wherein changing the shape of the deformable mirror includes actuating a microelectromechanical structure (MEMS) mirror.

13. An automatic data collection device to read data carriers such as machine-readable symbols, the automatic data collection device comprising:
a light source to generate light;
a deformable mirror positioned to receive the generated light and to direct the received light;
a scanning mirror positioned to have the directed light incident thereon, the scanning mirror being movable to direct the incident light to a target machine-readable symbol as a scanning beam;
a light detector to detect light returned from the target machine-readable symbol; and
a processor coupled to the light detector to evaluate the returned light and from the returned light, to provide feedback information indicative of a property associated with the scanning beam, the processor further being coupled to the deformable mirror to control change of a shape of the deformable mirror based on the feedback information.

14. The device of claim 13 wherein the light detector is adapted to generate analog signal representative of the returned light, the device further comprising:
an analog-to-digital converter coupled to the light detector to change the analog signal to a digital signal; and
a machine-readable medium to store a decoding algorithm to process the digital signal to decode data encoded by the target machine-readable symbol, wherein the processor is coupled to evaluate the analog signal, the digital signal, or the decoded data to determine the feedback information indicative of the property associated with the scanning beam.

15. The device of claim 14 wherein the property associated with the scanning beam is a focal distance, a depth of field, a divergence, or a wavefront shape.

16. The device of claim 13, further comprising a machine-readable medium to store a focus control algorithm that can determine a degree of focus of the scanning beam, the processor being coupled to the machine-readable medium to execute the focus control algorithm to determine whether to change the shape of the deformable mirror based on the degree of focus.

17. The device of claim 13 wherein the deformable mirror includes:
a reflective surface made from a reflective metal material;
a silicon membrane underlying the reflective metal material; and
at least one electrode proximate the silicon membrane to, if provided with a voltage potential, apply an electrical force to the silicon membrane to cause the silicon membrane to deform.

18. The device of claim 17 wherein the at least one electrode comprises a plurality of electrodes in an arrangement, wherein the plurality of electrodes are arranged asymmetrically relative to a center of the reflective material, in a manner that voltage potentials applied to the electrodes results in asymmetric curvature of the reflective material relative to the center.

19. The device of claim 13 wherein the shape of the deformable mirror can be changed to a substantially flat shape, parabolic shape, partially elliptical shape, or asymmetric curve shape.

20. The device of claim 13, further comprising a lens positioned between the light source and the deformable mirror to collimate the generated light.

21. An automatic data collection device for reading data carriers such as machine-readable symbols, the device comprising:
means for generating a light beam;
deformable means for controlling a property associated with the generated light beam;
means for directing the generated light beam to a target machine-readable symbol;
means for receiving light returned from the target machine-readable symbol;
means for evaluating the received light to provide feedback information indicative of the property associated with the light beam; and
means for changing a shape of the deformable means based on the feedback information.

22. The device of claim 21 wherein the deformable means includes a reflective surface and means for generating asymmetric curvature of the reflective surface.

23. The device of claim 21 wherein the property comprises a focal distance, depth of field, divergence, or wavefront shape.

24. An article of manufacture, comprising:
a machine-readable medium having instructions stored thereon that are executable by a processor of an automatic data collection device to read data carriers such as machine-readable symbols, by:
causing generation of a light beam that is directed to a deformable mirror;
deforming the deformable mirror to control a property associated with the light beam;
actuating a scanning mirror to direct the light beam to a target machine-readable symbol;
evaluating light received from the target machine-readable symbol determine the property associated with the light beam; and
changing a shape of the deformable mirror based on the determined property.

25. The article of manufacture of claim 24 wherein the instructions to change the shape of the deformable mirror includes instructions to asymmetrically change the shape of the deformable mirror to compensate for an aberration due to an angle of incidence of the generated light on the deformable mirror.

26. The article of manufacture of claim 24 wherein the instructions to evaluate the received light include instructions to evaluate an analog form of the received light, a digital form of the received light, or decoded data from the received light to determine either or both a focal distance or a depth of field.

27. The article of manufacture of claim 24 wherein the instructions to change the shape of the deformable mirror includes instructions to individually address and apply voltage potentials to electrodes that generate electrostatic forces that deform the deformable mirror.

28. A method to manufacture an automatic data collection device for reading data carriers such as machine-readable symbols, the method comprising:
producing a mirror substrate portion having a deformable silicon membrane and a reflective material overlying the deformable silicon membrane;
producing an electrode substrate portion, the electrode substrate portion having a cavity to sized to accommodate deformation of the deformable silicon membrane and having at least one electrode that is offset from a center of the cavity in a manner that application of a voltage potential to the at least one electrode causes generation of force against the deformable silicon membrane to asymmetrically deform the deformable silicon membrane relative to the center of the cavity;
bonding the mirror substrate portion to the electrode substrate portion to form a deformable mirror; and
assembling the deformable mirror into an automatic data collection device.

29. The method of claim 28 wherein assembling the deformable mirror into the automatic data collection device includes placing the deformable mirror in a scanner-type data collection device.

30. The method of claim 28 wherein assembling the deformable mirror into the automatic data collection device includes placing the deformable mirror in an imaging-type data collection device.

31. The method of claim 28, further comprising sealing at least some exposed surfaces of the deformable mirror.

32. The method of claim 28 wherein producing the mirror substrate portion includes:
forming the deformable silicon membrane on buried silica over bulk silicon;
performing a thermal oxidizing to form a first silica layer over the deformable silicon membrane and a second silica layer underlying the bulk silicon;
performing plasma enhanced chemical vapor deposition (PECVD) to deposit silica over the second silica layer;
applying a first photoresist over the first silica layer, and performing a first photolithography and etching process thereon to form a first cavity that extends into the bulk silicon;
removing the first photoresist;
applying a second photoresist over the deposited silica that overlies the second silica layer, and performing a second photolithography and etching process thereon to form a second cavity that extends to the buried silica;
removing the buried silica in the second cavity and the first silica layer to expose the deformable silicon membrane; and
overlying the exposed deformable silicon membrane in the second cavity with the reflective material.

33. The method of claim 28 wherein producing the electrode substrate portion includes:
performing thermal oxidation to form a silica layer over a silicon wafer;
depositing a conductive metal material over the silica layer;
performing a first photolithography and etching process on the conductive metal material to define the electrodes, including the at least one offset electrode;
performing a PECVD process to encapsulate the electrodes in silica;
performing a second photolithography and etching process on the encapsulate silica to form thrusts to support the mirror substrate portion; and
performing a third photolithography and etching process on the encapsulate silica up to the electrodes to form the cavity sized to accommodate deformation of the deformable silicon membrane.

34. The method of claim 28 wherein producing the mirror substrate portion and producing the electrode substrate portions include producing MEMS substrate portions.
